(19) United States
(12) Patent Application Publication
(10) Pub. No.: US 2025/0219932 A1
(43) Pub. Date: Jul. 3, 2025

(54) LINEAR PACKET NETWORK CODING TO IMPROVE TRANSMISSION RELIABILITY IN MULTIPATH TRANSMISSIONS

(71) Applicant: Intel Corporation, Santa Clara, CA (US)

(72) Inventors: Wei MAO, Pleasanton, CA (US); Hosein NIKOPOUR, San Jose, CA (US)

(21) Appl. No.: 18/398,281

(22) Filed: Dec. 28, 2023

(51) Int. Cl. H04L 45/24; H04L 47/36; H04L 47/43

(52) U.S. Cl. CPC H04L 45/24; H04L 47/36; H04L 47/43

(57) ABSTRACT

Disclosed herein are devices, methods, and systems for encoding data packets for transmitting over at least two transmission paths, which may include a sub-6 GHz link and multiple high frequency band links. The system may divide an upper layer packet into a predefined number of equal-sized segments, encode the segments with linear packet network coding to generate a set of network coded packets, allocate for transmission to a destination node over two or more transmission paths subsets of the set of network coded packets to corresponding ones of the two or more transmission paths, and transmit to the destination node each subset of the subsets of network coded packets on its corresponding transmission path of the two or more transmission paths. The linear packet network coding may be optimized using a recursive method to allocate packets using decoding success probability and/or through a steepest decent or equalized distribution algorithm

### TECHNICAL FIELD

The disclosure relates generally to wireless transmissions, and in particular, to wireless transmissions that utilize more than one wireless transmission path to transmit upper layer data packets.

### BACKGROUND

As wireless communication protocols continue to develop, new spectrum and new configurations allow for faster data transmission. For example, high frequency bands (HFB) such as mmWave and sub-THz may be an important aspect of 6G communication systems because HFB links may offer large bandwidth (BW) and capacity that support high data rates. However, due to the narrow beam width and high penetration loss on HFB links, such HFB links may be easily susceptible to blockage effects caused by moving objects such as humans and cars that may block or impair physical signal transmissions. The duration of a blockage may be relatively long (˜500 ms), which may be particularly problematic for some 6G use cases, for example, that require both high reliability and low delay for the transmission. Thus, supporting such use cases on HFB links may be challenging. This may also be true for multiple HFB links that may support a data transmission, because all of the multiple HFB links may be blocked, which is not a negligible probability (e.g., 10⁻⁴ for 4 links in typical scenarios, which would not meet the typical 10⁻⁶˜10⁻⁹ high-reliability requirement in 6G). To meet the quality of service (QoS) requirements of such use cases, lower frequency bands (e.g., sub-6 GHz bands that may also be supported in 6G) may be needed. However, sub-6 GHz resources may be expensive and it may be undesirable to use a large number of sub-6 GHz links.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows a basic example of linear packet-level coding (also called network coding or NC) that may be used for encoding and decoding wireless transmissions;

FIG. 2 shows an exemplary linear coding block that uses linear coding on the input packets to generate encoded packets that are then transmitted to a receiver node;

FIG. 3 shows an example recursive algorithm for calculating network coding reliability on transmission links;

FIG. 4 illustrates an exemplary optimization algorithm for efficiently utilizing resources in a multi-link transmission that may include a sub-6 GHz link and high-frequency band (HFB) links;

FIG. 5 shows an exemplary algorithm for a steepest decent mapping method that may be used with a binary search to locate a minimum;

FIG. 6 depicts an example plot of a simulated delay incurred by transmitting packets on a multi-link transmission on the sub-6 GHz and HFB links;

FIG. 7 shows an example plot of a simulated average traffic load fraction on the sub-6 GHz link when different numbers of HFB links exist;

FIG. 8 shows an example plot of a simulated reliability achieved using a conventional packet duplication technique over the sub-6 GHz link with multiple available HFB links;

FIG. 9 depicts an example plot of a simulated cumulative distribution of the delay incurred by transmitting the NC packets on the HFB links;

FIG. 10 shows an example plot of a simulated cumulative distribution of the average traffic load fraction on the sub-6 GHz link when different numbers of HFB links exist;

FIG. 11 illustrates an example plot of a simulated distribution of runtimes of two different search algorithms for different numbers of initially available HFB links;

FIG. 12 shows an example plot of a simulated distribution of the runtime ratio of the two different search algorithms;

FIG. 13 shows an exemplary schematic drawing of a device for linear packet-level coding of a multi-link transmission; and

FIG. 14 depicts a schematic flow diagram of an exemplary method for linear packet-level coding of a multi-link transmission.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

As noted above, high frequency bands (HFB) such as mmWave and sub-THz may offer large bandwidth (BW) and capacity that support high data rates. However, due to the narrow beam width and high penetration loss on HFB links, such HFB links may be easily susceptible to blockage effects caused by moving objects such as humans and cars that may block or impair physical signal transmissions. To meet the quality of service (QoS) requirements for certain use cases that require high-reliability and low delay, lower frequency bands (e.g., sub-6 GHz bands) may be needed to support the data transmission. However, sub-6 GHz resources may be expensive and it may be undesirable to use a large number of sub-6 GHz links to support the data transmission.

Discussed in more detail below, the disclosed linear packet network coding scheme may determine an optimized utilization of available transmission paths so as to use, for example, the smallest number of sub-6 GHz links while also maintaining the required reliability and delay for the transmission. In current systems, packet duplication on layer 2 may be used to utilize multiple links, but the spectral efficiency is often low and may not be sufficient to meet the high reliability requirement (e.g., due to blockage of the HFB links). Higher layer protocols such as multi-path transmission control protocol (MTCP) may also take advantage of multiple data paths to increase reliability, but such higher layer protocols may rely on retransmissions to achieve reliability, which may incur an unacceptably higher delay.

In contrast to the above packet duplication and MTCP, the disclosed linear packet network coding may provide a more spectrally-efficient way of utilizing the combined bandwidth (BW) of multiple transmission links to improve packet reliability with low latency so as to meet the reliability and latency requirements. In particular, the linear packet network coding disclosed below may be particularly useful when a sub-6 GHz link is used as one of the multiple transmission links, whose radio resource may be more expensive than HFB links. As discussed in more detail below, for a hybrid case where one or more sub-6 GHz links are used with HFB links, the disclosed linear packet network coding improves computational speeds for the algorithm used to optimally distribute the packets, as compared to an exhaustive searching algorithm, which may be computationally expensive. The linear packet-level network coding discussed below may utilize proactive redundancy to data packets and a low-complexity packet allocation algorithm to optimally distribute the encoded packets across all links to achieve the required reliability with low latency, while ensuring that, for example, the minimum number of sub-6 GHz links are used. The low-complexity packet allocation algorithm may use a fast recursive algorithm, which speed up the calculation to compute the reliability of network coding (NC) over multiple links that may have blockage-and transmission-caused errors.

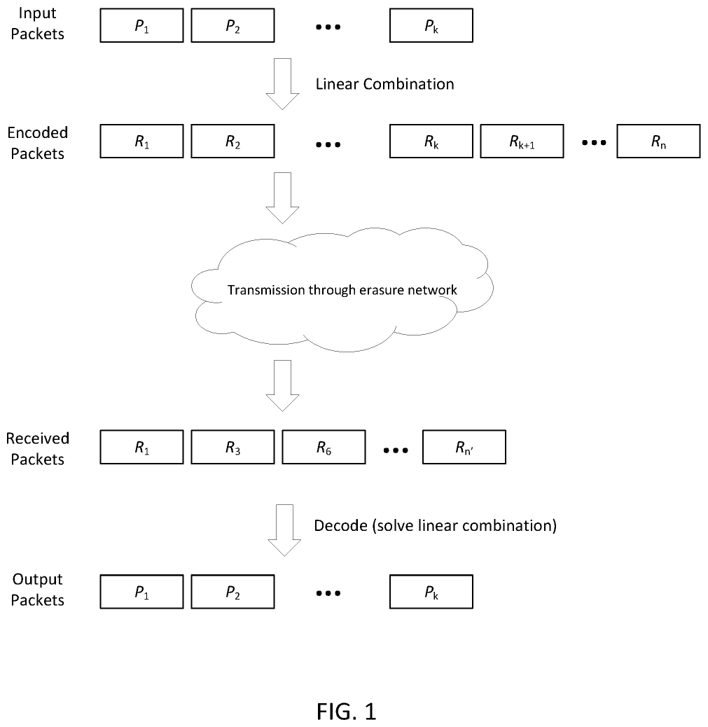

FIG. 1 shows the basic concept of linear packet-level code (also called network coding or NC). Given a set of same-sized packets [P₁, P₂, . . . , Pₖ] represented as column vectors over a Galois Field [symbol] , a linearly coded packet may be constructed as R=Σᵢ₌₁^{k}cᵢ·Pᵢ, where the encoding vector [c₁, c₂ . . . , cₖ]^{T} may consist of coefficients chosen from [symbol] . Multiple such linearly coded packets with different encoding vectors may be transmitted through a lossy network. If a receiver receives k of the encoded packets [R₁, R₂, . . . , Rₖ] that are linearly independent, then it may be able to recover the original packets [P₁, P₂, . . . , Pₖ] using:

$$[ {R}_{1} {R}_{2} … {R}_{k} ] {M}^{- 1} , where M = [ \begin{matrix}{c}_{1}^{1} & {c}_{1}^{2} & … & {c}_{1}^{k} \\ {c}_{2}^{1} & {c}_{2}^{2} & … & {c}_{2}^{k} \\ ⋮ & ⋮ & … & ⋮ \\ {c}_{k}^{1} & {c}_{k}^{2} & … & {c}_{k}^{k}\end{matrix} ] ,$$

the i-th column of which consists of the encoding vector for Rᵢ.

As should be understood, the linear code may be any type of well-designed set of codes such that receiving any k out of n encoded packets may ensure successful decoding. Examples of such coding sets include, for example, Reed-Solomon codes, MDS (maximum distance separable) codes, turbo codes, low-density parity check (LDPC) codes, etc. As should also be understood, the encoding and decoding may be performed by one or more processors (e.g., an encoding processor and a decoding processor) which may be on the respective source (e.g., a source node) or destination device (e.g., a destination node) or may be distributed among multiple different locations. As should also be understood, wireless transmissions between a source node and a destination node may be accomplished via a wireless transceiver (e.g., a wireless transmitter and/or a wireless receiver) that transmits and receives according to a communications protocol, such as the wireless and cellular standards published by the 3rd Generation Partnership Project (3GPP) and the Institute of Electrical and Electronics Engineers (IEEE), including, for example IEEE 802.11 (Wi-Fi) and 3GPP cellular protocols such as WCDMA, HSUPA, LTE, and emerging cellular standards like 5G, 6G, etc. The linear packet network coding scheme discussed herein may be applicable to any currently existing or to-be-developed wireless communication standard.

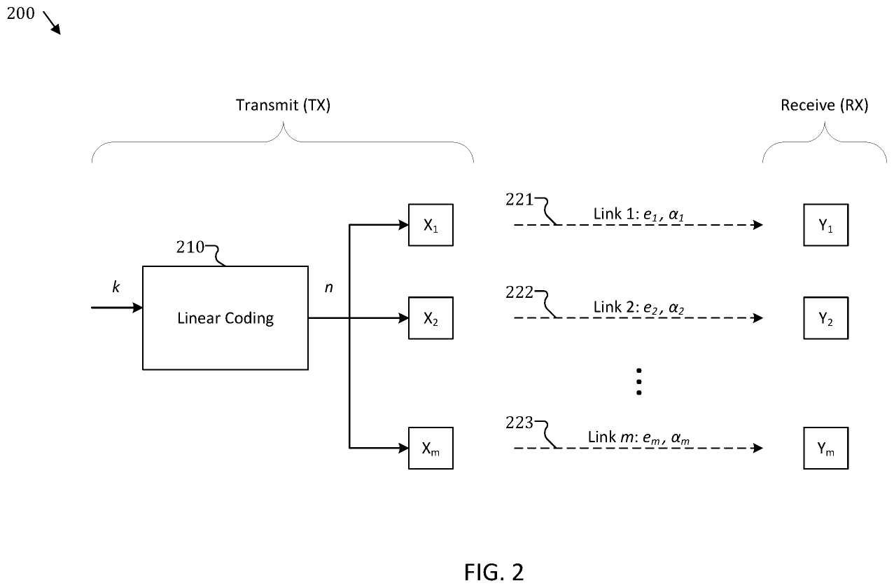

In transmission schemes that utilize multiple transmission links from a source to a destination, the linearly coded packets may be transmitted over and therefore traverse any transmission link. Scenarios in which multiple transmission links may be utilized include multiple cells, multiple access points, multi-connectivity, multi-RAT, multiple carriers (e.g., carrier aggregation), etc. In terms of coding such transmissions, k information packets may be encoded into n encoded packets through a lossy network, which consists of m independent links. The upper layer packet may be divided into a predefined number of equally sized segments, represented by k, and the predefined segments may then be encoded and into n encoded packets and allocated to the multiple transmission links. An example of linear network encoding and decoding 200 is shown, for example, in FIG. 2 that shows a linear coding block 210 that uses linear coding on the input packets to generate encoded packets that are then transmitted to the receiver (e.g., via transmission links 221, 222, and up to m links, represented by link 223). The total number of encoded packets n are distributed among the available links i, where i=1 . . . m such that xᵢ is the number of packets distributed to link i and Σᵢ₌₁^{m}xᵢ=n. Each link transmits is corresponding xᵢ of packets. As long as the destination (e.g., a receiver) receives k of the n encoded packets, the original packets may be recovered. Hence, the probability (F) of failing to decode the k input information packets is defined as:

$$F ( {x}_{1} , … , {x}_{m} ; k ) := Pr ( {\sum }_{i = 1}^{m} {Y}_{i} < k ) , \qquad ( 1 )$$

where Yᵢ is the number of successfully received packets after possible packet drop on path i.

The packet transmission process on each link i may be subject to both transmission errors and link blockage. The transmission errors may be characterized by independent and identically distributed (i.i.d.) packet erasures across different links and different packets, with a probability eᵢ for each link i. The link blockage phenomenon, which may be more problematic for the HFB (mmWave/sub-THz) bands, typically last in a dynamic case at least on the order of hundreds of milliseconds whenever they happen. Dynamic link blockage may be modeled as a Poisson arrival process with some arrival rate λᵢ for each link i, and hence within the transmission time (denoted Tᵢ for link i) of each packet, the link blockage events happen independent and identically distributed with a probability αᵢ=1−e^{-λ}^{ᵢ}^{T}^{ᵢ}. Even if the blockage process is not Poisson, the calculation may still appropriately model the blockage process, as long as the occurrence of blockage is independent and identically distributed during each packet's transmission time. If link i uses a sub-6 GHz band, then the blockage probability αᵢ=0.

For delay-sensitive data transmissions (e.g., where there may be a latency requirement for the transmission on the order of or smaller than tens of milliseconds), it may be assumed that every upper layer packet is divided into k lower layer packets, which are linearly encoded into n coded packets and transmitted over the multi-link network. Whenever a link blockage event happens during the transmission of these packets, all subsequent packets on the corresponding link are dropped and are not useful, because even if they could be recovered at a later time, this later time would cause the transmission to exceed its latency requirement for the upper layer packet. Hence, in this type of scenario, there may be a packet erasure event caused by a link blockage on a link i, which may be modeled as a bursty erasure process that may last until the end of the transmission for this group of coded packets.

To address the problems discussed above, the linear packet network coding scheme may utilize an algorithm where the probability of failing to recover an upper layer packet that is divided, linearly coded, and allocated to multiple transmission links (e.g., as shown in FIG. 1 above) is F(x₁, . . . , xₘ; k), as defined by the equation above. The upper layer packet may be divided into a predefined number of equally sized segments, represented by k, and these predefined segments may then be encoded and into n encoded packets and allocated to the multiple transmission links. While this may be directly calculated, a direct calculation may involve high complexity (e.g., at least O(n^{m})) and thus may involve high computing costs. To reduce computing costs, the algorithm may utilize a recursive method and calculate the complement of the F function, which is the decoding success probability fᵣ=1−F. In the algorithm below, for each link i:

$${q}_{i} = {e}_{i} ( 1 - {α}_{i} ) ; and$$

$${s}_{i} := \frac{( 1 - {e}_{i} ) ( 1 - {a}_{i} )}{1 - {e}_{i} ( 1 - {a}_{i} )} = 1 - \frac{{a}_{i}}{1 - {q}_{i}} ,$$

which, as explained above, may reduce to eᵢ and 1 respectively when αᵢ=0 (e.g., when the transmission link i is a sub-6 GHz link).

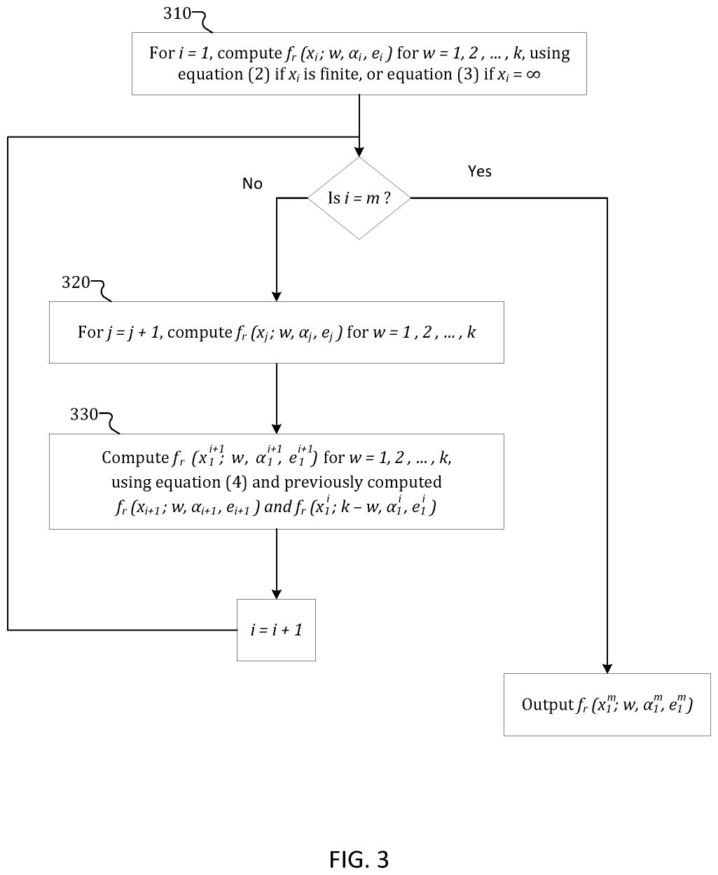

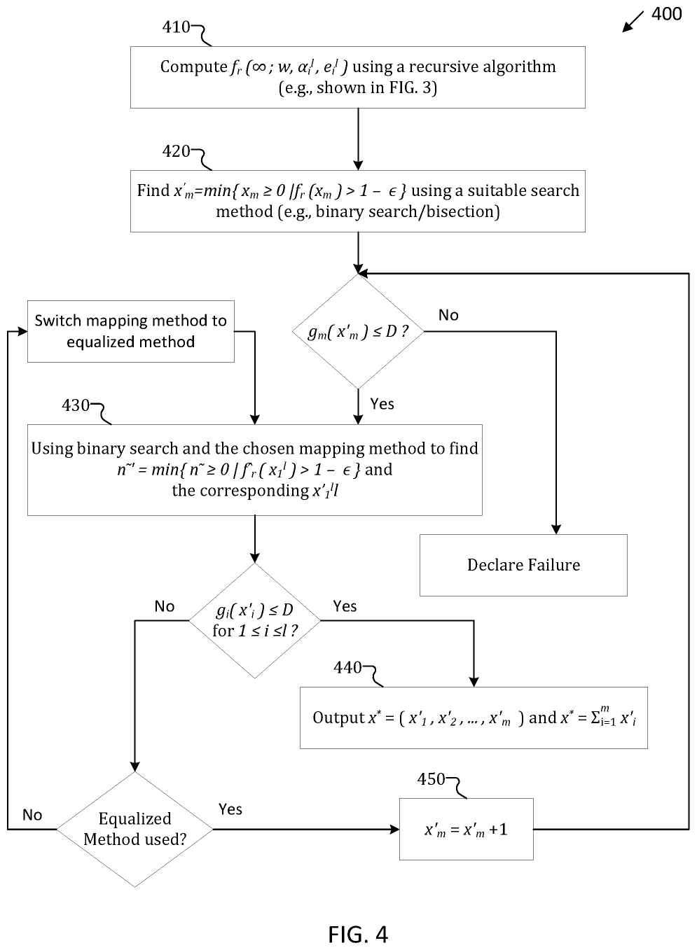

With the above in mind, a recursive method may be used to calculate network coding reliability. A flowchart showing the below-described recursive algorithm is shown in FIG. 3. In 310, the decoding success probability fᵣ on a single transmission link i may be calculated as:

$${f}_{r} ( {x}_{i} ; k , {α}_{i} , {e}_{i} ) = {s}_{i}^{k} [ 1 - {F}_{B} ( k - 1 , {x}_{i} , 1 - {q}_{i} ) ] , \qquad ( 2 )$$

where F_{B} is the cumulative distribution function (CDF) of the binomial distribution:

$${F}_{B} ( k - 1 , {x}_{i} , 1 - {q}_{i} ) := {\sum }_{l = 0}^{k - 1} ( \begin{matrix}{x}_{i} \\ l\end{matrix} ) {( 1 - {q}_{i} )}^{l} {q}_{i}^{{x}_{i} - l} .$$

Note that when xᵢ→∞ the expression still holds:

$${f}_{r} ( ∞ ; k , {α}_{i} , {e}_{i} ) := {lim}_{{x}_{i \to ∞}} {f}_{r} ( {x}_{i} ; k , {α}_{i} , {e}_{i} ) = {s}_{i}^{k} . \qquad ( 3 )$$

Assuming that the function values fᵣ have been calculated, in 320, up to k packets for links 1, 2, . . . , j with parameters x₁^{j}=(x₁, x₂, . . . , xⱼ), e₁^{j}=(e₁, e₂, . . . , eⱼ) and α₁^{j}=(α₁, α₂, . . . , αⱼ). That is, fᵣ(x₁^{j}; w, α₁^{j}, e₁^{j}) is known for w=1, 2, . . . , k, then the decoding success probability fᵣ for links 1, 2, . . . , j+1 with parameters x₁^{j+1}, e₁^{j+1} and α₁^{j+1} may be calculated, in 330, as:

$${f}_{r} ( {x}_{1}^{j + 1} ; k , {α}_{1}^{j + 1} , {e}_{1}^{j + 1} ) = {f}_{r} ( {x}_{j + 1} ; k , {α}_{j + 1} , {e}_{j + 1} ) + {\sum }_{w = 0}^{k - 1} [ \text{} {f}_{r} ( {x}_{j + 1} ; w , {α}_{j + 1} , {e}_{j + 1} ) - {f}_{r} ( {x}_{j + 1} ; w + 1 , {α}_{j + 1} , {e}_{j + 1} ) ] {f}_{r} ( {x}_{1}^{j} ; k - w , {a}_{1}^{j} , {e}_{1}^{j} ) , \qquad ( 4 )$$

where fᵣ(xⱼ₊₁; 0, αⱼ₊₁, eⱼ₊₁)=1.

It should be noted that the recursion may also hold when some or all of the coordinates approach infinity (e.g., xᵢ→∞). The complexity of the recursive algorithm of FIG. 3 may be O(mk²).

As noted above, using only HFB links in a multilink transmission may not be sufficient to meet the stringent QoS requirements of high-reliability, delay-sensitive data transmission. As a result, one or more of the multiple links may need to be in a lower frequency band (e.g., a sub-6 GHz link). As also noted above, sub-6 GHz bandwidth may be much more expensive than HFB bandwidth, and so it may be beneficial to use, if possible, just one sub-6 GHz link and also to minimize its utilization in terms of radio resources. The algorithm below provides an optimization for utilization of the sub-6 GHz link in a multi-link transmission that satisfies the reliability and latency requirements. In the equations below, the total number of HFB links established between the transmitter (TX) and the receiver (RX) is given by L. In addition to the L HFB links, there is also a single sub-6 GHz link.

Some or all of the L HFB links may not be available for use at the time of packet transmission, because, as described above, they may be in the blocked state. As should be understood, the TX side may constantly monitor the channel conditions of each transmission link so that it knows which links are blocked at what time. The transmitter may share this information with the encoder so that when encoding and transmitting each group of k packets, only the non-blocked links are utilized. As a result, at the time of transmission for each upper layer packet, some number l≤L may be the number of non-blocked HFB transmission links to be utilized for transmitting the upper layer packet. Using this scenario with reference to FIG. 3, the sub-6 GHz link and the l available HFB links would constitute the multi-link transmission network and so m=l+1.

As one example, without loss of generality, link m may be a sub-6 GHz link while the first l=m−1 links are HFB links. The upper layer packet may then be divided into k lower layer packets and encoded into n coded packets, which are then transmitted through the m links. The reliability requirement of the upper layer packet is denoted by ϵ, which means that the decoding failure probability of the k packets should be no larger than ϵ. The delay bound of the upper layer packet is denoted by D, which is assumed to be too stringent to allow for any retransmissions of packets. For each i let gᵢ(xᵢ) denote the time needed to transmit xᵢ packets on link i. Then the optimization problem may determine the total number of encoded packets n and how many of these packets are distributed to each available link i (denoted by xᵢ), to meet the following requirements: (1) reliability target is to be achieved within delay D, thus fᵣ(x₁^{m}; k, α₁^{m}, e₁^{m})>1−ϵ with gᵢ(xᵢ)≤D for 1≤i≤m; (2) the number of packets xₘ transmitted on link m (the sub-6 GHz link) is to be minimized; and (3) given that xₘ is minimized, the total number of packets ñ:=Σᵢ₌₁^{l}xᵢ transmitted on HFB links is also minimized to efficiently utilize resources on the HFB links.

The optimization problem may be solved using, for example, algorithm 400 shown in FIG. 4 and described below.

In 410, algorithm 400 may compute the limiting reliability performance for the first l links

$${f}_{r} ( ∞ ; w , {α}_{1}^{l} , {e}_{1}^{l} ) := {lim}_{\begin{matrix}{x}_{i \to ∞} \\ 1 \leq i \leq l\end{matrix}} {f}_{r} ( {x}_{1}^{l} ; w , {α}_{1}^{l} , {e}_{1}^{l} )$$

for w=1, 2, . . . , k using the recursive method for calculating network coding reliability as discussed above.

In 420, algorithm 400 may determine the minimal integer xₘ≥0 that satisfies \tilde{f}ᵣ(xₘ)>1−ϵ using the common binary search/bisection method, as \tilde{f}ᵣ is a single variable function. Where x′ₘ denotes the minimal value, if the incurred delay gₘ(x′ₘ)>D, then the delay constraint cannot be met on this set of transmission links and algorithm 400 declares a failure. Otherwise algorithm 400 may continue with 430. As should be understood, by fixing xₘ=x′ₘ on the sub-6 GHz link and transmitting finite numbers of packets x₁^{l}=(x₁, x₂, . . . , xₗ) on the HFB links, the NC decoding success probability may be expressed using equation (4) above and expressed by:

$${\hat{{f}_{r}} ( {x}_{1}^{l} ) := {f}_{r} ( {x}_{1}^{m} ; k , {α}_{1}^{m} , {e}_{1}^{m} ) \vert}_{{x}_{m} = {x}_{m}^{′}} = {f}_{r} ( {x}_{m}^{′} ; k , {α}_{m} , {e}_{m} ) + {\sum }_{w = 0}^{k - 1} [ {f}_{r} ( {x}_{m}^{′} ; w , {α}_{m} , {e}_{m} ) - {f}_{r} ( {x}_{m}^{′} ; w + 1 , {α}_{m} , {e}_{m} ) ] {f}_{r} ( {x}_{1}^{′} ; k - w , {α}_{1}^{l} , {e}_{1}^{l} ) ,$$

which is a function of the numbers of packets transmitted on the HFB links and may be computed using equation (2) above and the recursive method for calculating network coding reliability as discussed above.

In 430, the goal is to find the minimal integer ñ≥0 that satisfies \hat{f}ᵣ(x₁^{l})>1−ϵ using a binary search/bisection method to map a given ñ (the total number of packets transmitted over the HFB links) to x₁^{l} (the numbers of packets distributed to the individual HFB links). In a binary search, it takes the largest number and continues to half the number until the calculated performance requirement is not met. Then, it averages the last number for ñ and the current number for ñ. The mapping may be done, for example, by an equalized mapping method, a steepest decent mapping method, etc. when used in the binary search. In an equalized mapping method, for example, q may be the quotient and r may be remainder of dividing ñ by l, thus ñ=ql+r with 0≤r<l. Then, the equalized mapping method sets r coordinates of x₁^{l} to be q+1 while it sets the remaining l−r coordinates to be q. For example, the equalized method may set x₁= . . . =xᵣ=q+1 and xᵣ₊₁= . . . =xₗ=q. This method may provide for minimal delay on the HFB links when used in the binary search . . .

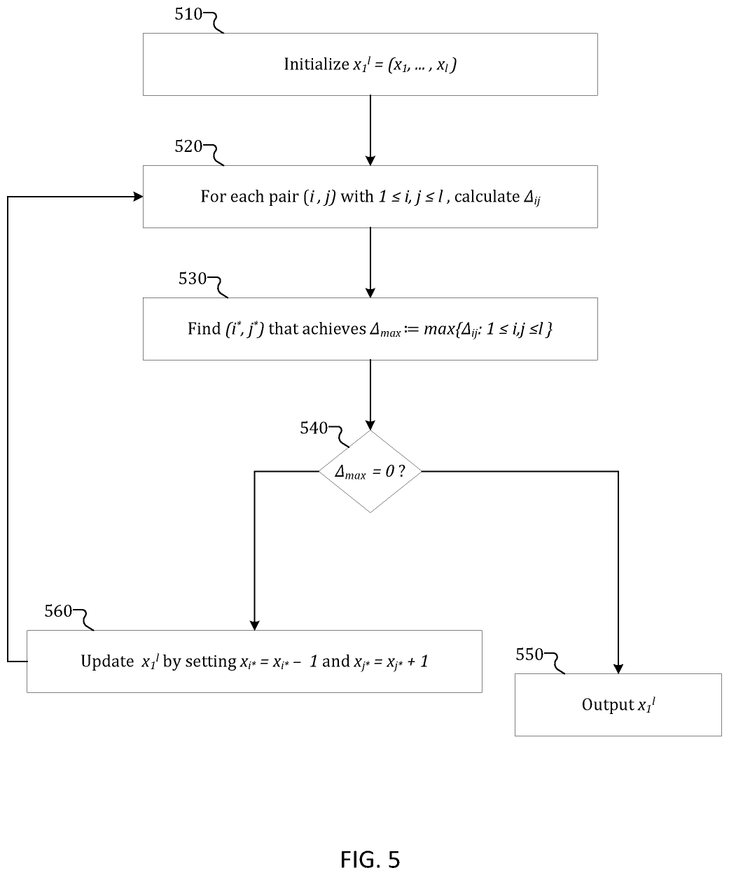

A steepest descent mapping method aims to achieve the best reliability \hat{f}ᵣ(x₁^{l}) over the HFB links with low complexity and, in doing so, tries to output the smallest possible ñ when used with the binary search. Given the total number of encoded packets ñ=Σᵢ₌₁^{l}xᵢ to be transmitted over the HFB links, the steepest descent method may try to find x₁^{l}=(x₁, x₂, . . . , xₗ) (i.e., the numbers of packets distributed to the individual links) to maximize the NC decoding success probability expression \hat{f}ᵣ(x₁^{l}). The flowchart of an example of the steepest decent method is shown in FIG. 5 and its empirical complexity is O(ñ).

In 510, the steepest decent mapping method initializes x₁^{l}=(x₁, . . . , xₗ) to be an arbitrary allocation of ñ packets. For example, the initial allocation may be an equalized allocation (i.e., the output of the equalized method discussed above), where the difference of the number of allocated packets between any two links is no more than 1. For 1≤i,j≤l with i≠j and xᵢ>0, the expression \tilde{x}₁^{l}=(\tilde{x}₁, . . . , \tilde{x}ₗ) may be an allocation obtained from (x₁, . . . , xₗ) by moving 1 packet from link i to link j. In 520, for every such (i, j) pair, the steepest decent method calculates Δᵢⱼ:=\hat{f}ᵣ(\tilde{x}₁^{l})−\hat{f}ᵣ(x₁^{l}), which is the change of decoding success probability. For all other values of (i, j) set Δᵢⱼ=0. The goal is in 530, which is to find (i*, j*) that achieves Δₘₐₓ:=max{Δᵢⱼ: 1≤i,j≤l}, where (i*, j*) denotes the index pair that maximizes Δᵢⱼ among all (i, j). If, in 540, the maximum value is 0, then the steepest decent method may stop and output, at 550 (x₁, . . . , xₗ) as the final packet allocation (e.g., in this case, a local optimum is found). Otherwise the steepest decent method may, in 560, update (x₁, . . . , xₗ) by moving 1 packet from link i* to link j*, and then go back to 520.

The minimal ñ found above with a given mapping method is denoted by ñ′ and the corresponding packet distribution on the HFB links is denoted by x′₁^{l}=(x′₁, x′₂, . . . , x′ₗ). The equalized method may be particularly suitable for homogeneous HFB links, meaning that all (e₁, e₂, . . . , eₗ) are the same and all (α₁, α₂, . . . , αₗ) are the same. In such a case, the equalized distribution may be optimal and may achieve the best reliability. The steepest descent method may be particularly suitable for heterogeneous HFB links, meaning that the parameters may be different across the links. As should be appreciated, while the equalized method and the steepest decent method have been described as examples of ways to find the minimal integer ñ≥0 that satisfies \hat{f}ᵣ(x₁^{l})>1−ϵ in the binary search, other suitable searching methods may be used to determine the optimal reliability and guarantee to output the smallest ñ, including, for example, exhaustive searching. As should be understood, however, other search methods such as exhaustive searching may be computationally expensive, due to their high complexity.

Returning to FIG. 4, after the minimal ñ has been found (e.g., using the selected mapping method), the delay is again checked against its requirement to be below D. If the delay constraint is satisfied (e.g., if gᵢ(x′ᵢ)≤D for 1≤i≤l), then the algorithm 400 outputs, at 440, x*=(x′₁, x′₂, . . . , x′ₘ) as the optimized packet distribution and n*=Σᵢ₌₁^{m}x′ᵢ as the total number of encoded packets. If the delay constraint is not satisfied, algorithm 400 may, if equalized mapping method was not used in 430, switch to start using equalized method as the mapping method and re-execute the binary search in 430. Otherwise, if the algorithm 400 was already using equalized mapping in 430, the algorithm may, in 450, increase x′ₘ by 1 (x′ₘ=x′ₘ+1) and redefine the function \hat{f}ᵣ(x₁^{l}) accordingly. If gₘ(x′ₘ)>D, then the delay constraint cannot be met and the algorithm declares a failure. Otherwise, algorithm 400 returns to 430 to re-execute the binary search in 430 with the new value of x′ₘ.

Described below are numerical results of two multi-link scenarios that demonstrate how the above-described linear packet network coding scheme may improve the performance. In both scenarios, the established transmission links include 1 sub-6 GHz link and up to L=4 HFB links. In the first scenario, the parameters of all HFB links are the same, and these are listed below together with the parameters for the sub-6 GHz link:

| | | | | | | | Blocked |
|---|---|---|---|---|---|---|---|
| Frequency | TTI | | | | | Blockage | state |
| band | (Tᵢ) | | λᵢ | eᵢ | αᵢ | time | prob. |
| Sub-6 GHz | 1 | ms | 0 | 0.1 | 0 | 0 | 0 |
| HFB (mmWave/ | ⅛ | ms | 0.2 bl/s | 0.1 | 2.5e⁻⁵ | 0.5 s | 0.0952 |
| sub-THz) | | | | | | | |

As discussed earlier each HFB link may be in the blocked state and cannot be used for transmission when an NC group is ready for transmission. For purposes of modelling the scenario, the blockage time was assumed to be a constant (0.5 s). With the blocker arrival rate λᵢ (0.2 bl/s), the probability of an HFB link i being in the blocked state at any given time is 0.0952. Each upper layer packet is divided into k segments (i.e., a predefined number of equally-sized lower layer packet segments) of a fixed and equal size of 1500 bytes for the purpose of linear packet network coding. We assume that on each link it takes exactly one TTI to transmit a segment (Tᵢ=1 TTI). The reliability requirement for the upper layer packet is 10⁻⁶, which cannot be achieved without the help of a sub-6 GHz link, even using the maximum number of HFB links (when L=4), as the probability of all of them being blocked is 0.0952⁴≈8×10⁻⁵.

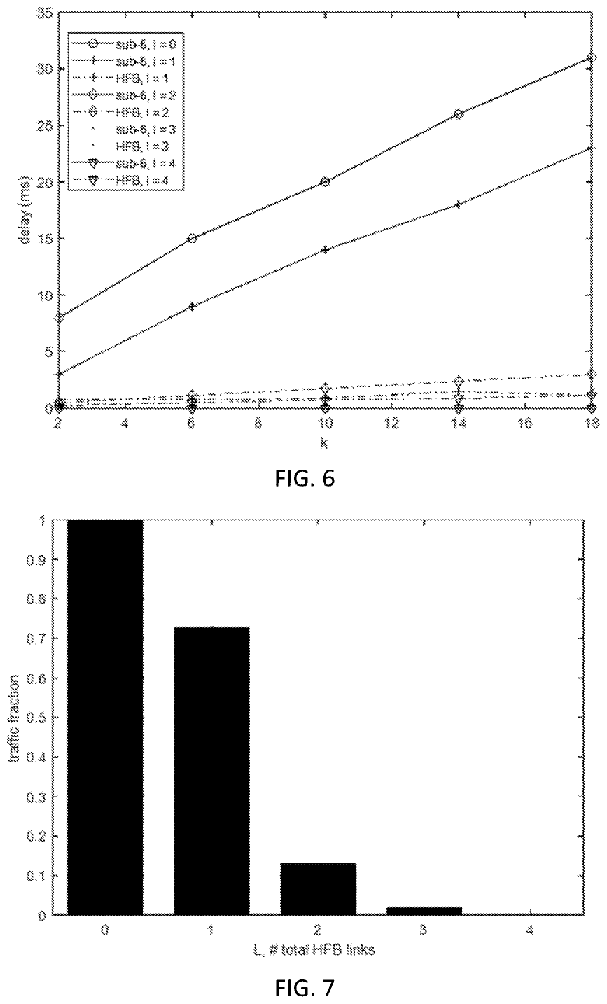

Adding 1 sub-6 GHz link may help meet this reliability target if the required delay bound D can be supported on the sub-6 GHz link. For each number of initially available HFB links l, where 0≤l≤L, the recursive method discussed above with respect to FIG. 3 was used by the simulation to obtain the optimal number of packets NC needed on each HFB link and the sub-6 GHz link to achieve the required reliability. As the HFB links in this scenario are homogeneous, the simulation uses the equalized mapping method discussed above. FIG. 6 shows the corresponding delay incurred by transmitting packets on the sub-6 GHz and HFB links are plotted for each k (which is proportional to the size of the upper layer packet, because the upper layer packet is divided into a predefined number of equally sized k segments that are then encoded and into n encoded packets and allocated to the multiple transmission links), when l HFB links are available initially. As can be seen in FIG. 6, the delay on the HFB links is much smaller than that incurred when only the sub-6 GHz link is used, and so the packet transmission delay on the HFB links is not a limiting factor of the system. For moderately short delay (e.g., D=20 ms) with moderate packet size (e.g., k=10), a reliability target of 10⁻⁶ may be supported.

Given the resource-expensive nature of a sub-6 GHz link, being able to offload more traffic onto more HFB links may be advantageous from a resource cost perspective. FIG. 7 shows the average traffic load fraction on the sub-6 GHz link when different numbers of HFB links (L) exist, which reflects the long-term average traffic load. Note that at different times each HFB link may or may not be blocked, and so when encoding and transmitting each upper layer packet, a different number (l) of HFB links may be available for use. The results in FIG. 7 take into account this randomness of the HFB link blockage state and are averaged over all random scenarios. As can be seen, 2˜4 HFB links may significantly reduce the traffic load on the sub-6 GHz link.

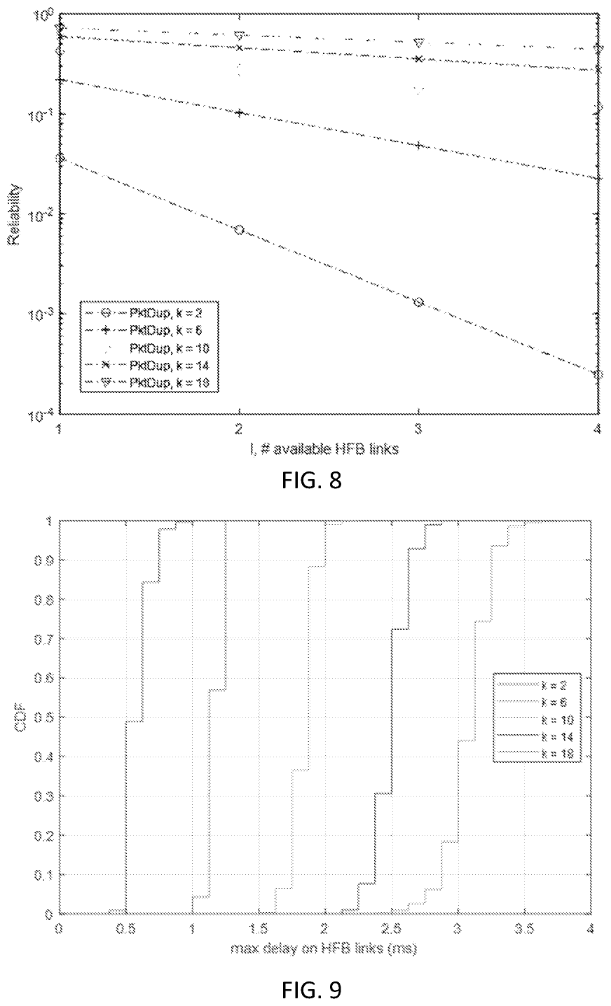

In contrast, FIG. 8 shows the reliability achieved using a conventional packet duplication technique over the sub-6 GHz link and up to l available HFB links. Even if l=4 HFB links are available initially, packet duplication is not able to achieve the reliability target of 10⁻⁶.

In the second scenario, all the parameters are the same as the first scenario except that the parameters eᵢ and λᵢ for the HFB links are now randomly generated, within the range 0.01˜0.1 and 0.1˜1, respectively. The simulation generates approximately 1000 random scenarios and obtains the cumulative distributions of the results. The simulation applies the optimization algorithm 400 discussed above with respect to the FIG. 4 with the steepest decent mapping method discussed with respect to FIG. 5 (as the HFB links are heterogeneous, the steepest decent mapping method may be preferred over the equalized mapping method or other mapping methods).

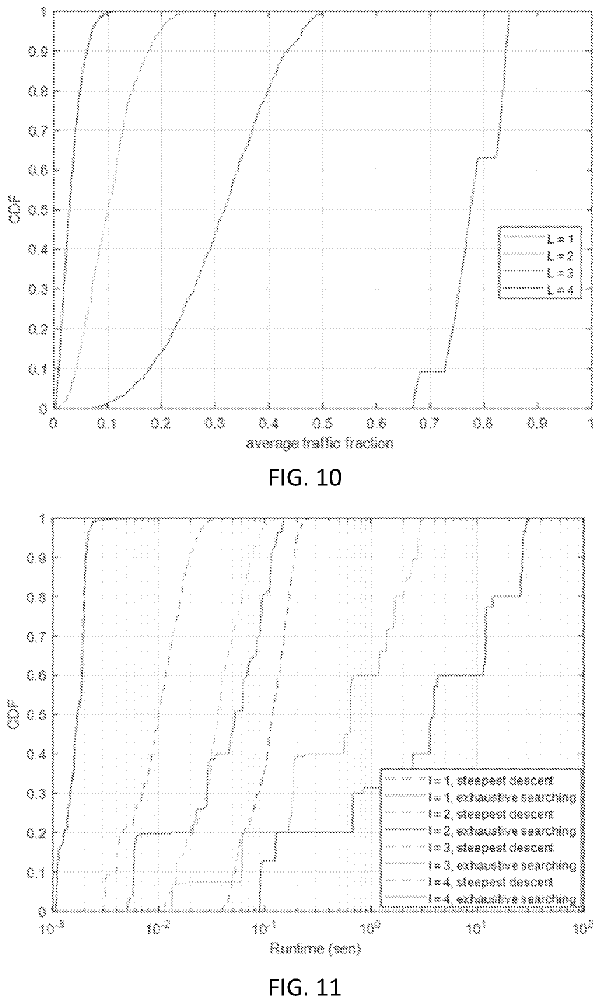

In this scenario and with this simulation, FIG. 9 shows the cumulative distribution of the delay incurred by transmitting the NC packets on the HFB links. As the sub-6 GHz link parameters are the same as the first setting, when compared with FIG. 6, it can be seen that the delay on the HFB links with random parameters continue to be much smaller than that incurred when only the sub-6 GHz link is used, and so the packet transmissions on HFB links are not the bottleneck of the system. FIG. 10 provides an example cumulative distribution of the average traffic load fraction on the sub-6 GHz link when different numbers of HFB links (L) exist, when the number of segments k=10. As can be seen, using 3˜4 HFB links with random parameters may still significantly reduces the traffic load on the sub-6 GHz link.

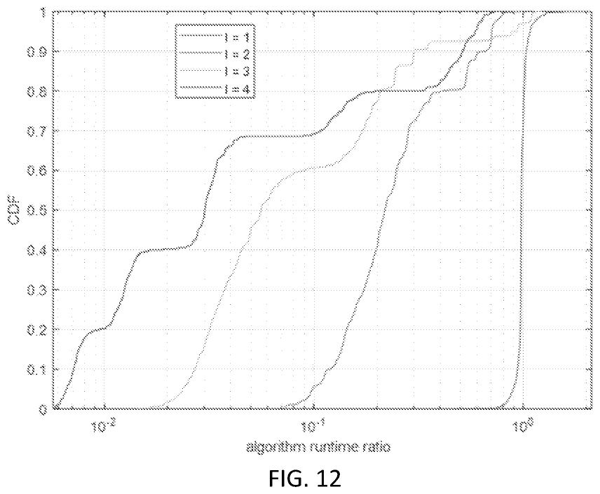

The performances of using the steepest descent mapping method to optimize the packet distribution over the HFB links was compared with using the exhaustive searching method, which is guaranteed to find the optimum packet distribution. For this simulation, approximately 100 random scenarios were run. In all cases, the steepest descent algorithm outputs the same packet distribution as exhaustive searching, so it was able to achieve the optimum in all 100 random scenarios. In addition, the distribution of runtimes of the two algorithms (accounting for different k) are plotted in FIG. 11 for different numbers of initially available HFB links (l). As can be seen, for all k values, the steepest descent mapping method consistently takes a smaller runtime to achieve the optimum, while the exhaustive searching algorithm may take much longer (e.g., two-orders of magnitude longer) runtime to finish the computation. FIG. 12 plots the distribution of the runtime ratio of the two algorithms, which also demonstrates the runtime improvement from using the steepest descent algorithm may reach more than two-orders of magnitude.

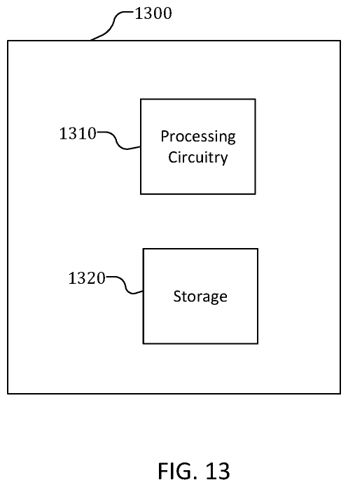

FIG. 13 is a schematic drawing illustrating a device 1300 for encoding data packets for transmission over at least two transmission paths, which may include a sub-6 GHz link and multiple high frequency band links. Device 1300 may include any of the features of the linear packet network coding described above. The linear packet network coding system of FIG. 13 may be implemented as a device, a method, and/or a computer readable medium that, when executed, performs the features of the linear packet network coding systems described above. It should be understood that device 1300 is only an example, and other configurations may be possible that include, for example, different components or additional components.

Device 1300 includes processing circuitry 1310 connected to storage 1320. In addition to or in combination with any of the features described in the following paragraphs, processing circuitry 1310 is configured to divide an upper layer packet into a predefined number of equal-sized segments. In addition to or in combination with any of the features described in the following paragraphs, processing circuitry 1310 is further configured to encode the segments with a linear packet network coding to generate a set of network coded packets. In addition to or in combination with any of the features described in the following paragraphs, processing circuitry 1310 is further configured to allocate, for transmission to a destination node over two or more transmission paths, subsets of the set of network coded packets to corresponding ones of the two or more transmission paths. In addition to or in combination with any of the features described in the following paragraphs, processing circuitry 1310 is further configured to transmit to the destination node each subset of the subsets of network coded packets on its corresponding transmission path of the two or more transmission paths.

Furthermore, in addition to or in combination with any of the features described in this or the previous paragraph, the processing circuitry 1310 configured to encode and allocate may include the processing circuitry 1310 configured to determine a total number of packets in the set of network coded packets based on the predefined number of segments and a size of each subset, encode the segments with the linear packet network coding to generate the set of network coded packets based on a network coding configuration for the linear packet network coding and the total number of packets, allocate the subsets to corresponding ones of the two or more transmission paths based on the size of each subset. Furthermore, in addition to or in combination with any of the features described in this or the previous paragraph, processing circuitry 1310 may be further configured to determine the total number of packets and the size of each subset based on an algorithm that relates the predefined number, a reliability target, and a threshold delay for packet transmission to the total number of packets and the size of each subset based.

Furthermore, in addition to or in combination with any of the features described in this or the previous two paragraphs, the algorithm may further relate, for each of the two or more transmission paths, a packet erasure probability and a blockage probability to the total number of packets and the size of each subset for its corresponding transmission path. Furthermore, in addition to or in combination with any of the features described in this or the previous two paragraphs, processing circuitry 1310 configured to determine the size of each subset may include processing circuitry 1310 configured to determine a reliability of the network coding configuration based on a reliability algorithm that relates, for each of the two or more transmission paths, the predefined number, the packet erasure probability, and the blockage probability to a decoding success probability. Furthermore, in addition to or in combination with any of the features described in this or the previous two paragraphs, the reliability algorithm may include a recursive calculation of the decoding success probability.

Furthermore, in addition to or in combination with any of the features described in this or the previous three paragraphs, at least one of the two or more transmission paths may include a sub-6 GHz frequency band link and others of the two or more transmission paths may include high frequency band (HFB) links. Furthermore, in addition to or in combination with any of the features described in this or the previous three paragraphs, at least one of the two or more transmission paths may be within a sub-6 GHz frequency band and others of the two or more transmission paths may be within a high frequency band (HFB), wherein processing circuitry 1310 may be further configured to determine the total number of packets and the size of each subset based on a limiting reliability performance of the HFB links, a minimal size of the subset corresponding to the sub-6 GHz frequency band link to be delivered to the sub-6 GHz link, and/or an optimized size of the subsets corresponding to the HFB links. Furthermore, in addition to or in combination with any of the features described in this or the previous three paragraphs, processing circuitry 1310 may be further configured to determine the size of each subset of encoded packets further based on a binary search with a steepest descent algorithm. Furthermore, in addition to or in combination with any of the features described in this or the previous three paragraphs, processing circuitry 1310 may be further configured to determine the optimized size of the subsets corresponding to the HFB links based on a binary search with an equalized distribution algorithm.

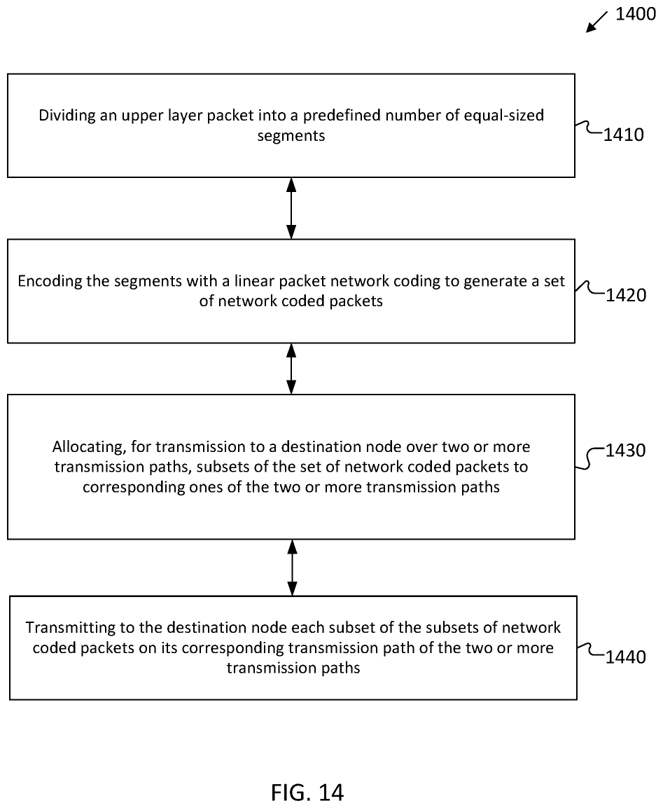

FIG. 14 depicts a schematic flow diagram of a method 1400 for encoding data packets for transmission over at least two transmission paths, which may include a sub-6 GHz link and multiple high frequency band links. Method 1400 may implement any of the features of the linear packet network coding described above.

Method 1400 includes, in 1410, dividing an upper layer packet into a predefined number of equal-sized segments. Method 1400 also includes, in 1420, encoding the segments with a linear packet network coding to generate a set of network coded packets. Method 1400 also includes, in 1430, allocating, for transmission to a destination node over two or more transmission paths, subsets of the set of network coded packets to corresponding ones of the two or more transmission paths. Method 1400 also includes, in 1430, transmitting to the destination node each subset of the subsets of network coded packets on its corresponding transmission path of the two or more transmission paths.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising a processor configured to:
divide an upper layer packet into a predefined number of equal-sized segments;
encode the equal-sized segments with a linear packet network coding to generate a set of network coded packets;
allocate, for transmission to a destination node over two or more transmission paths, subsets of the set of network coded packets to corresponding ones of the two or more transmission paths; and
transmit to the destination node each subset of the subsets of network coded packets on its corresponding transmission path of the two or more transmission paths.

2. The device of claim 1, wherein the processor configured to encode and allocate comprises the processor configured to:
determine a total number of packets in the set of network coded packets based on the predefined number of equal-sized segments and a size of each subset;
encode the equal-sized segments with the linear packet network coding to generate the set of network coded packets based on a network coding configuration for the linear packet network coding and the total number of packets; and
allocate the subsets to corresponding ones of the two or more transmission paths based on the size of each subset.

3. The device of claim 2, wherein the processor is further configured to determine the total number of packets and the size of each subset based on an algorithm that relates the predefined number, a reliability target, and a threshold delay for packet transmission to the total number of packets and the size of each subset based.

4. The device of claim 3, wherein the algorithm further relates, for each of the two or more transmission paths, a packet erasure probability and a blockage probability to the total number of packets and the size of each subset for its corresponding transmission path.

5. The device of claim 4, wherein the processor configured to determine the size of each subset comprises the processor configured to determine a reliability of the network coding configuration based on a reliability algorithm that relates, for each of the two or more transmission paths, the predefined number, the packet erasure probability, and the blockage probability to a decoding success probability.

6. The device of claim 5, wherein the reliability algorithm comprises a recursive calculation of the decoding success probability.

7. The device of claim 1, wherein at least one of the two or more transmission paths comprises a sub-6 GHz frequency band link and others of the two or more transmission paths comprise high frequency band (HFB) links.

8. The device of claim 2, wherein at least one of the two or more transmission paths is within a sub-6 GHz frequency band and others of the two or more transmission paths are within a high frequency band (HFB), wherein the processor is further configured to determine the total number of packets and the size of each subset based on a limiting reliability performance of the HFB links, a minimal size of the subset corresponding to the sub-6 GHz frequency band link to be delivered to the sub-6 GHz link, and/or an optimized size of the subsets corresponding to the HFB links.

9. The device of claim 2, wherein the processor is configured to determine the size of each subset of encoded packets further based on a binary search with a steepest descent algorithm.

10. The device of claim 8, wherein the processor is configured to determine the optimized size of the subsets corresponding to the HFB links based on a binary search with an equalized distribution algorithm.

11. A system for transmitting data packets over at least two transmission paths, the system comprising:
a source node comprising a wireless transmitter and an encoding processor; and
a destination node comprising a wireless receiver and a decoding processor, wherein the encoding processor is configured to:
divide an upper layer packet into a predefined number of equal-sized segments;
encode the equal-sized segments with a linear packet network coding to generate a set of network coded packets;
allocate subsets of the set of network coded packets to corresponding ones of the at least two transmission paths; and
cause the wireless transmitter to transmit to the destination node each subset on its corresponding transmission path of the at least two transmission paths, wherein the decoding processor is configured to:
cause the wireless receiver to receive the set of network coded packets;
decode back into the equal-sized segments the set of network coded packets according to the linear packet network coding; and
assemble the equal-sized segments into the upper layer packet.

12. The system of claim 11, wherein the encoding processor configured to encode and allocate comprises the encoding processor configured to:
determine a total number of packets in the set of network coded packets based on the predefined number of equal-sized segments and a size of each subset; and
encode the equal-sized segments with the linear packet network coding to generate the set of network coded packets based on a network coding configuration for the linear packet network coding and the total number of packets; and
allocate the subsets to corresponding ones of the at least two transmission paths based on the size of each subset.

13. The system of claim 12, wherein the encoding processor is further configured to determine the total number of packets and the size of each subset based on an algorithm that relates the predefined number, a reliability target, and a threshold delay for packet transmission to the destination node.

14. The system of claim 13, wherein the algorithm further relates, for each of the at least two transmission paths, a packet erasure probability and a blockage probability to the total number of packets and the size of each subset for its corresponding transmission path.

15. The system of claim 14, wherein the encoding processor configured to determine the size of each subset comprises the processor configured to determine a reliability of the network coding configuration based on an a recursive calculation of a decoding success probability that relates, for each of the at least two transmission paths, the predefined number, the packet erasure probability, and the blockage probability to a decoding success probability.

16. The system of claim 11, wherein at least one of the at least two transmission paths comprises a sub-6 GHz frequency band link and others of the at least two transmission paths comprise high frequency band (HFB) links.

17. The system of claim 12, wherein at least one of the at least two transmission paths is within a sub-6 GHz frequency band and others of the at least two transmission paths are within a high frequency band (HFB), wherein the processor is further configured to determine the total number of packets and the size of each subset based on a limiting reliability performance of the HFB links, a minimal size of the subset corresponding to the sub-6 GHz frequency band link to be delivered to the sub-6 GHz link, and/or an optimized size of the subsets corresponding to the HFB links.

18. The system of claim 12, wherein the encoding processor is configured to determine the size of each subset of encoded packets based on a binary search with a steepest descent algorithm, an equalized distribution algorithm, and/or an exhaustive search algorithm.

19. A non-transitory computer-readable medium comprising instructions, which, when executed by one or more processors, cause the one or more processors to:
divide an upper layer packet into a predefined number of equal-sized segments;
encode the equal-sized segments with a linear packet network coding to generate a set of network coded packets, wherein a total number of packets in the set of network coded packets is based on the predefined number of equal-sized segments and a size of each subset, wherein the encoding is based on a network coding configuration for the linear packet network coding and the total number of packets;
allocate, for transmission to a destination node over two or more transmission paths, subsets of the set of network coded packets to corresponding ones of the two or more transmission paths, wherein the allocating is based on a size of each subset; and transmit to the destination node each subset of the subsets of network coded packets on its corresponding transmission path of the two or more transmission paths.

20. The non-transitory computer-readable medium of claim 19, wherein the instructions also cause the one or more processors to determine the total number of packets and the size of each subset based on an algorithm that relates the predefined number, a reliability target, a threshold delay for packet transmission, and, for each of the two or more transmission paths, a packet erasure probability and a blockage probability to the total number of packets and the size of each subset for its corresponding transmission path.
